(19) United States
(12) Patent Application Publication
(10) Pub. No.: US 2003/0103892 A1
(43) Pub. Date: Jun. 5, 2003

(54) Promoted cobalt-chromium oxide catalysts on lanthanide-modified supports and process for producing synthesis gas

(75) Inventors: Tianyan Niu, Ponca City, OK (US); Bang C. Xu, Houston, TX (US); Daxiang Wang, Ponca City, OK (US)

Correspondence Address: DAVID W. WESTPHAL, CONOCO PHILLIPS, P.O. BOX 1267, PONCA CITY, OK, 74602-1267, US

(73) Assignee: Conoco Inc., Houston, TX (US)

(21) Appl. No.: 10/268,632

(22) Filed: Oct. 10, 2002

Related U.S. Application Data
(60) Provisional application No. 60/330,024, filed on Oct. 17, 2001.

(51) Int. Cl. B01J 23/10; C01B 3/26

(52) U.S. Cl. 423/651; 502/302

(57) ABSTRACT

Catalysts comprising promoted cobalt-chromium oxide disposed on a lanthanide coated refractory support that are active for catalyzing the net partial oxidation of methane or natural gas to products containing CO and H₂ are disclosed, along with short contact time processes employing the new catalysts for producing synthesis gas. Preferred promoters are rhodium and cerium, and a preferred lanthanide coating material is ytterbium.

### CROSS-REFERENCE TO RELATED APPLICATIONS

This application claims the benefit under 35 U.S.C. 119(e) of U.S. Provisional Patent Application No. 60/330,024 filed Oct. 17, 2001, the disclosure of which is hereby incorporated herein by reference.

### BACKGROUND OF THE INVENTION

1. Field of the Invention

The present invention generally relates to processes and catalysts for the catalytic partial oxidation of hydrocarbons (e.g., natural gas) to produce a mixture of carbon monoxide and hydrogen (“synthesis gas” or “syngas”). More particularly, the invention relates to such processes and catalysts in which the catalyst comprises cobalt and chromium.

2. Description of Related Art

The quantities of methane, the main component of natural gas, are available in many areas of the world, and natural gas is predicted to outlast oil reserves by a significant margin. However, most natural gas is situated in areas that are geographically remote from population and industrial centers. The costs of compression, transportation, and storage make its use economically unattractive.

To improve the economics of natural gas use, much research has focused on methane as a starting material for the production of higher hydrocarbons and hydrocarbon liquids. The conversion of methane to hydrocarbons is typically carried out in two steps. In the first step, methane is reformed with water to produce carbon monoxide and hydrogen (i.e., synthesis gas or syngas). In a second step, the syngas intermediate is converted to higher hydrocarbon products by processes such as the Fischer-Tropsch Synthesis. For example, fuels with boiling points in the middle distillate range, such as kerosene and diesel fuel, and hydrocarbon waxes may be produced from the synthesis gas.

Current industrial use of methane as a chemical feedstock proceeds by the initial conversion of methane to carbon monoxide and hydrogen by either steam reforming, which is the most widespread process, or by dry reforming or by autothermal reforming. Steam reforming currently is the major process used commercially for the conversion of methane to synthesis gas, proceeding according to Equation 1.

CH₄+H₂O⇄CO+3H₂ (1)

Although steam reforming has been practiced for over five decades, efforts to improve the energy efficiency and reduce the capital investment required for this technology continue. For many industrial applications, the 3:1 ratio of H₂:CO products is problematic, and the typically large steam reforming plants are not practical to set up at remote sites of natural gas formations.

Methane residence times in steam reforming are on the order of 0.5-1 second, whereas for heterogeneously catalyzed partial oxidation, the residence time is on the order of a few milliseconds. For the same production capacity, syngas facilities for the partial oxidation of methane can be far smaller, and less expensive, than facilities based on steam reforming. A recent report (M. Fichtner et al., Ind. Eng. Chem. Res. (2001) 40:3475-3483) states that for efficient syngas production, the use of elevated operation pressures of about 2.5 MPa is required. Those authors describe a partial oxidation process in which the exothermic complete oxidation of methane is coupled with the subsequent endothermic reforming reactions (water and CO₂ decomposition). This type of process can also be referred to as autothermal reforming or ATR, especially when steam is co-fed with the methane. Certain microstructured rhodium honeycomb catalysts are employed which have the advantage of a smaller pressure drop than beds or porous solids (foams) and which resist the reaction heat of the total oxidation reaction taking place at the catalyst inlet.

The catalytic partial oxidation (“CPOX”) or direct partial oxidation of hydrocarbons (e.g., natural gas or methane) to syngas has also been described in the literature. In catalytic partial oxidation, natural gas is mixed with air, oxygen-enriched air, or oxygen, and introduced to a catalyst at elevated temperature and pressure. The partial oxidation of methane yields a syngas mixture with a H₂:CO ratio of 2:1, as shown in Equation 2.

CH₄+½O₂→CO+2H₂ (2)

This ratio is more useful than the H₂:CO ratio from steam reforming for the downstream conversion of the syngas to chemicals such as methanol or to fuels. The CPOX reaction is exothermic, while the steam reforming reaction is strongly endothermic. Furthermore, oxidation reactions are typically much faster than reforming reactions. This allows the use of much smaller reactors for catalytic partial oxidation processes that is possible in a conventional steam reforming process.

While its use is currently limited as an industrial process, the direct partial oxidation or CPOX of methane has recently attracted much attention due to its inherent advantages, such as the fact that due to the significant heat that is released during the process, there is no requirement for the continuous input of heat in order to maintain the reaction, in contrast to steam reforming processes. An attempt to overcome some of the disadvantages and costs typical of steam reforming by production of synthesis gas via the catalytic partial oxidation of methane is described in European Patent No. 303,438. According to that method, certain high surface area monoliths coated with metals or metal oxides that are active as oxidation catalysts, e.g., Pd, Pt, Rh, Ir, Os, Ru, Ni, Cr, Co, Ce, La, and mixtures thereof, are employed as catalysts. Other suggested coating metals are noble metals and metals of groups IA, IIA, III, IV, VB, VIB, or VIIB of the periodic table of the elements.

U.S. Pat. No. 5,149,464 describes a method for selectively converting methane to syngas at 650-950° C. by contacting a methane/oxygen mixture with a solid catalyst which is a d-block transition metal on a refractory support, an oxide of a d-block transition metal, or a compound of the formula MₓM′_{y}O_{z} wherein M′ is a d-block transition metal and M is Mg, B, Al, Ga, Si, Ti, Zr, Hf or a lanthanide. M is at least one element selected from Mg, B, Al, Ln, Ga, Si, Ti, Zr and Hf, Ln is at least one member of lanthanum and the lanthanide series of elements, and each of the ratios x/z and y/z and (x+y)/z is independently from 0.1 to 8; or (b) an oxide of a d-block transition metal; or (c) a d-block transition metal on a refractory support; or (d) a catalyst formed by heating a) or b) under the conditions of the reaction or under non-oxidizing conditions. Each of the ratios x/z and y/z and (x+y)/z is independently from 0.1 to 8, preferably from 0.2 to 1.0.

U.S. Pat. No. 5,500,149 describes the combination of dry reforming and partial oxidation of methane, in the presence of added CO₂ to enhance the selectivity and degree of conversion to synthesis gas. U.S. Pat. No. 5,431,855 demonstrates the catalytic conversion of mixtures of CO₂, O₂ and CH₄ to synthesis gas over selected alumina supported transition metal catalysts. Maximum CO yield reported was 89% at a gas hourly space velocity (GHSV) of 1.5×10⁴ hr⁻¹, temperature of 1,050° K and pressure of 100 kPa. The addition of CO₂ tends to reduce the H₂:CO ratio of the synthesis gas, however.

For successful commercial scale operation a catalytic partial oxidation process must be able to achieve a high conversion of the methane feedstock at high gas hourly space velocities, and the selectivity of the process to the desired products of carbon monoxide and hydrogen must be high. Dietz III and Schmidt (Catalysis Letters (1995) 33:15-29) describe the effects of 1.4-6 atmospheres pressure on methane conversion and product selectivities in the direct oxidation of methane over a Rh-coated foam monolith. The selectivities of catalytic partial oxidation to the desired products, carbon monoxide and hydrogen, are controlled by several factors. One of the most important of these factors is the choice of catalyst composition. In most of the existing syngas production processes it is difficult to select a catalyst that will be economical for large scale industrial use, yet will provide the desired level of activity and selectivity for CO and H₂ and demonstrate long on-stream life. Moreover, such high conversion and selectivity levels must be achieved without detrimental effects to the catalyst, such as the formation of carbon deposits (“coke”) on the catalyst, which severely reduces catalyst performance. Accordingly, substantial effort in this field continues to be devoted to the development of catalysts allowing commercial performance without coke formation. Also, in order to overcome the relatively high pressure drop associated with gas flow through a fixed bed of catalyst particles, and to make possible the operation of the reactor at high gas space velocities, various types of structures for supporting the active catalyst in the reaction zone have been proposed. For example, U.S. Pat. No. 4,844,837 (R M Heck and P Flanagan/Engelhard Corporation) describes certain catalysts for the partial oxidation of methane. Those catalysts contain a platinum group metal, optionally supplemented with one or more of chromium, copper, vanadium, cobalt, nickel and iron, and supported on a high surface area alumina-coated refractory metal oxide monolith. The alumina coating is stabilized by a rare earth metal oxide and/or alkaline earth metal oxide against an undesired high temperature phase transition to alpha alumina.

Y. Lu et al. (Cuihua Xeubao (1995) 16:447-452) describe certain supported Co catalysts for CO₂ reforming of methane to syngas. Addition of a small amount of La₂O₃ promoter brought about a slight drop in initial activity of an alumina supported catalyst. Use of a CaCO₃ promoter was preferred in that study.

PCT Patent Application Pub. No. WO 90/06297 (Korchnak et al./Davy McKee Corporation) describe certain monolith catalysts coated with metals or metal oxides such as Pa, Pt, Rh, Ir, Os, Ru, Ni, Cr, Co, Ce and La, noble metals and metals of Groups IA, IIA, III, IV, VB, VIB and VIIB of the Periodic Table of the Elements for producing synthesis gas from a hydrocarbonaceous feedstock, oxygen, and optionally, steam.

PCT Patent Application Pub. No. WO 93/01130 (Bhattacharya/University of Warwick) describes a catalyst for the production of carbon monoxide from methane. The catalyst is composed of Pd, Pt, Rh or Ir on a pure lanthanide oxide, which may be carried on a ceramic support, preferably zirconia. Pd on Sm₂O₃ gives relatively low selectivity for either CO or CO₂, compared to the selectivities reported for the other compositions evaluated in that study. The methane conversion process is performed with supplied heat, the feed gases comprise very low amount of O_{2,} and very low amounts of H₂ are produced as a byproduct of the process.

U.S. Pat. No. 5,447,705 (Petit et al./Institut Francais du Petrole) also discloses a process for the partial oxidation of methane to syngas by contacting the starting materials with a catalyst having a perovskite crystalline structure and having the composition LnₓA_{1-y}B_{y}O₃, in which x is a number such that 0<x<10, y is a number such that 0<y<1, Ln is at least one of a rare earth, strontium or bismuth, A is a metal of groups IVb, Vb, VIb, VIIb or VIII, A is a metal of groups IVb, Vb, VIb, VIIb or VIII and A and B are two different metals. Various combinations of La, Ni and Fe were exemplified.

U.S. Pat. No. 5,431,855 (Green et al./British Gas plc) describes a catalyst that catalyzes the combined partial oxidation-dry reforming reaction of a reactant gas mixture comprising CO₂, O₂ and CH₄ to for a product gas mixture comprising CO and H₂. Related patent U.S. Pat. No. 5,500,149 describes similar catalysts and methods for production of product gas mixtures comprising H₂ and CO.

U.S. Pat. No. 5,149,516 (Han et al./Mobil Oil Corp.) discloses a process for the partial oxidation of methane comprising contacting methane and a source of oxygen with a perovskite of the formula ABO_{3,} where B can be a variety of metals including Cr. In the example shown, the perovskite that was used is LaCoO₃.

M. Stojanovic et al., (J. Catal. (1997) 166 (2), 324-332) disclose the use of chromium-containing ternary perovskite oxides, LaCr₁₋ₓNiₓO₃ (x=0 to 1.0) as catalysts for the partial oxidation of methane to syngas. The catalytic activity was found to increase monotonically with the value of x, i.e., LaCrO₃ was found to be the least active catalyst.

Another potential disadvantage of many of the existing catalytic hydrocarbon conversion methods is the need to include steam in the feed mixture to suppress coke formation on the catalyst. Typically, the ratio of steam to methane, or other light hydrocarbon, in the feed gas must be maintained at 1:1 or greater. The volume of gaseous H₂O significantly reduces the available reactor space for the production of synthesis gas. Another disadvantage of using steam in the production of syngas is that steam increases the production of CO₂, which is carbon that is lost to the process of making CO product. Other existing methods have the potential drawback of requiring the input of a CO₂ stream in order to enhance the yield and selectivity of CO and H₂ products. Another drawback of some existing processes is that the catalysts that are employed often result in the production of significant quantities of carbon dioxide, steam, and C₂+ hydrocarbons. This often renders the product gas mixture unsuitable, for example, for feeding directly into a Fischer-Tropsch type catalytic system for further processing into higher hydrocarbon products. Moreover, for efficient syngas production, the use of elevated operation pressures is necessary in order to ensure the direct transition to a downstream process, such as a Fischer-Tropsch process, without the need for intermediate compression.

At the present time, none of the known processes appear capable of sufficiently high space-time yields. Typically, partial oxidation reactor operation under pressure is problematic because of shifts in equilibrium, undesirable secondary reactions, coking and catalyst instability. Another problem frequently encountered is loss of noble metals due to catalyst instability at higher operating temperatures. Although advancement has been made toward providing higher levels of conversion of reactant gases and better selectivities for CO and H₂ reaction products, problems still remain with finding sufficiently stable and long-lived catalysts capable of conversion rates that are attractive for large scale industrial use. Accordingly, a continuing need exists for better processes and catalysts for the production of synthesis gas, particularly from methane or methane containing feeds. In such improved processes the catalysts would be stable at high temperatures and resist coking. They would also retain a high level of conversion activity and selectivity to carbon monoxide and hydrogen under conditions of high gas space velocity and elevated pressures for long periods of time on-stream.

### SUMMARY OF THE INVENTION

The present invention provides a cobalt-chromium based catalyst and syngas production method that overcomes many of the problems associated with existing syngas processes and catalysts, and make possible the high space-time yields that are necessary for a commercially feasible syngas production facility. A process of preparing synthesis gas using supported Co—Cr oxide catalysts for the catalytic partial oxidation (CPOX) of methane or natural gas is disclosed. One advantage of the new cobalt-chromium containing catalysts employed in the process is that they demonstrate a high level of activity and selectivity to carbon monoxide and hydrogen under conditions of high gas hourly space velocity, elevated pressure and high temperature. The new catalyst structures contain more economical catalytic materials and overcome many of the drawbacks of previous syngas catalysts, to provide higher conversion and syngas selectivity. The catalyst used for producing synthesis gas comprises a rhodium or cerium promoter, a cobalt-chromium oxide compound of the general formula CoₓCr₁₋ₓ oxide (expressed in terms of atomic ratios of the metal components, wherein 0<x<1), preferably Co_{0.2}Cr_{0 8} oxide, and a lanthanide coated refractory support (e.g., 30-50 mesh zirconia or alumina). The lanthanide coating comprises at least one lanthanide element (i.e., La, Ce, Pr, Nd, Pm, Sm, Eu, Gd, Tb, Dy, Ho, Er, Tm, Yb and Lu, preferably Yb) in the form of the metal and/or metal oxide coating a refractory monolith or coating a plurality of distinct or discrete structures or particulates. The term “monolith” as used herein is any singular piece of material of continuous manufacture such as solid pieces of metal or metal oxide or foam materials or honeycomb structures. The terms “distinct” or “discrete” structures or units, as used herein, refer to supports in the form of divided materials such as granules, beads, pills, pellets, cylinders, trilobes, extrudates, spheres or other rounded shapes, or another manufactured configuration. Alternatively, the divided material may be in the form of irregularly shaped particles. Preferably at least a majority (i.e., >50%) of the particles or distinct structures have a maximum characteristic length (i.e., longest dimension) of less than six millimeters, preferably less than three millimeters.

The new cobalt-chromium based catalysts are preferably prepared by applying a rhodium or cerium precursor (e.g., a decomposable rhodium or cerium salt) to a cobalt-chromium oxide compound of the general formula CoₓCr₁₋ₓ oxide (expressed in terms of atomic ratios of the metal components, wherein 0<x<1), preferably Co_{0.2}Cr_{0 8} oxide, and depositing the combination onto a refractory support (e.g., 30-50 mesh zirconia or alumina) that has been coated with a lanthanide, lanthanide oxide, or a mixture of both, and stabilizing the catalyst structure. The term “refractory support” refers to any material that is mechanically stable to the high temperatures of a catalytic partial oxidation reaction, which is typically 500° C.-1,600° C., but may be as high as 2,000° C. Suitable refractory support materials include zirconia, magnesium stabilized zirconia, zirconia stabilized alumina, yttrium stabilized zirconia, calcium stabilized zirconia, alumina (preferably, α-alumina), cordierite, titania, silica, magnesia, niobia, vanadia. Other suitable supports are refractory nitride or carbide compounds.

“Stabilizing” means enhancing the resistance of the final catalyst structure to chemical and physical decomposition under the anticipated CPOX reaction conditions it will encounter when employed on stream in a syngas production reactor operated at superatmospheric feed gas pressures. Stabilizing preferably includes thermally conditioning the catalyst during catalyst construction, i.e., at intermediate and final stages of catalyst preparation. For example, after the lanthanide precursor compound is applied to the refractory support, it is subjected to one or more programmed heat treatments, and after the rhodium/cobalt-chromium oxide combination is applied to the lanthanide coated support, it is subjected to one or more heat treatments at elevated temperature, to yield a more stable and long lived catalyst for use in the CPOX reactor. Each heat treatment includes calcining the catalyst, or an intermediate stage of the catalyst, according to a defined heating and cooling program. Preferably at least the final heat treatment includes heating at a temperature that approaches or approximates the expected operating temperature of the CPOX reactor, or is within the operating range of the reactor. In certain embodiments, the stabilizing procedure comprises heating the catalyst at a predetermined heating rate up to a first temperature and then heating the catalyst at a predetermined heating rate from the first temperature to a second temperature. In some embodiments of the catalyst preparation method, the thermally conditioning also includes holding the catalyst, at the first and second temperatures for predetermined periods of time. In some embodiments, the first temperature is about 125-325° C. and the second temperature is about 300 to 900° C., preferably about 500-700° C. In some embodiments the heating rate is about 1-10° C./min, preferably 3-5° C./min and the holding or dwell time at that temperature is about 120-360 min, or more, preferably about 180 min. In some embodiments, the catalyst preparation method also includes reducing the catalyst at a predetermined temperature in a reducing atmosphere.

The above-described Rh or Ce/cobalt-chromium oxide/lanthanide catalysts, disposed on a refractory support, are characterized by enhanced activity for catalyzing the partial oxidation of light hydrocarbons such as methane, compared to unpromoted cobalt-chromium oxide catalysts. The new catalysts are more pressure tolerant, high temperature resistant and longer lived than presently available catalysts used for producing synthesis gas. These new catalysts have been shown to operate successfully at pressures above atmospheric pressure for longer periods of time on stream, over multi-day syngas production runs, without coking. The improved stability also manifests itself as more constant reactor exit temperatures and product gas compositions.

In accordance with other embodiments of the present invention, a method of partially oxidizing a reactant gas mixture comprising a light hydrocarbon and oxygen to form a product mixture containing carbon monoxide and hydrogen (synthesis gas or syngas) is provided. According to preferred embodiments, the method comprises passing the reactant gas mixture over the above-described catalyst in the catalytic reaction zone of a short contact time reactor, such that a product mixture containing CO and H₂ is produced. In some embodiments, the method includes passing the reactant gas mixture over the catalyst at a gas hourly space velocity of at least 20,000 hr⁻¹, and up to 100,000,000 hr⁻¹. In some embodiments, the method includes maintaining the reactant gas mixture at a pressure in excess of 100 kPa (about 1 atmosphere) while contacting the catalyst. In preferred embodiments, the pressure is up to about 32,000 kPa (about 320 atmospheres), more preferably between 200-10,000 kPa (about 2-100 atmospheres). In preferred embodiments, the method includes maintaining a catalyst residence time of no more than 10 milliseconds for each portion of the reactant gas mixture passing the catalyst by passing the reactant gas mixture over the catalyst at a gas hourly space velocity in the range of about 20,000-100,000,000 hr⁻¹.

In some embodiments, the syngas production method includes preheating the reactant gas mixture to about 30° C.-750° C. before contacting the catalyst. In some embodiments, the reactant gas mixture comprises a mixture of the methane or natural gas and the O₂-containing gas at a carbon:oxygen molar ratio of about 1.5:1 to about 3.3:1, preferably about 2:1. In some embodiments the hydrocarbon comprises at least about 80% methane by volume. In preferred embodiments of the method, the reactor is operated at the above-described process conditions to favor autothermal catalytic partial oxidation of the hydrocarbon feed and to optimize the yield and selectivity of the desired CO and H₂ products.

In accordance with certain embodiments of the present invention a method or process of converting methane or natural gas and O₂ to a product gas mixture containing CO and H₂, preferably in a molar ratio of about 2:1 H₂:CO, is provided. The process comprises mixing a methane-containing feedstock and an O₂ containing feedstock to provide a reactant gas mixture feedstock. Natural gas, or other light hydrocarbons having from 2 to 5 carbon atoms, and mixtures thereof, may also serve as satisfactory feedstocks. The O₂ containing feedstock may be pure oxygen gas, or may be air or O₂-enriched air. The reactant gas mixture may also include incidental or non-reactive species, in lesser amounts than the primary hydrocarbon and oxygen components. Some such species are H₂, CO, N₂, NOx, CO₂, N₂O, Ar, SO₂ and H₂S, as can exist normally in natural gas deposits. Additionally, in some instances, it may be desirable to include nitrogen gas in the reactant gas mixture to act as a diluent. Nitrogen can be present by addition to the reactant gas mixture or can be present because it was not separated from the air that supplies the oxygen gas. The reactant gas mixture is fed into a reactor where it comes into contact with a catalytically effective amount of catalyst. Advantageously, certain preferred embodiments of the process are capable of operating at superatmospheric reactant gas pressures (preferably in excess of 2 atmospheres or about 200 kPa) to efficiently produce synthesis gas.

According to certain preferred embodiments of the present invention, a highly productive process for partially oxidizing a reactant gas mixture comprising methane and oxygen to form synthesis gas comprising carbon monoxide and hydrogen is provided. This process comprises passing the reactant gas mixture over a rhodium or cerium promoted cobalt-chromium oxide catalyst comprising a lanthanide and/or lanthanide oxide coated refractory support in a reactor under process conditions that include maintaining a molar ratio of methane to oxygen ratio in the range of about 1.5:1 to about 3.3:1, the gas hourly space velocity is maintained in excess of about 20,000 hr⁻¹, the reactant gas mixture is maintained at a pressure in excess of about two atmospheres and at a preheat temperature of between about 30° C. and 750° C. Under these process conditions within the reactor, the high surface area catalyst structure causes the partial oxidation of the methane to proceed at high productivity, i.e., with at least 85% methane conversion, 85% selectivity to carbon monoxide and 85% selectivity to hydrogen. In preferred embodiments, the productivity is at least 90% methane conversion, 90% selectivity to carbon monoxide, and 90% selectivity to hydrogen, more preferably at least 95% methane conversion, 95% selectivity to carbon monoxide and 95% selectivity to hydrogen. In some embodiments, two or more catalyst monoliths are stacked in the catalyst zone of the reactor. In any case, the new Co—Cr oxide based catalyst systems or catalyst beds have sufficient porosity, or sufficiently low resistance to gas flow, to permit a stream of said reactant gas mixture to pass over the catalyst at a gas hourly space velocity (GHSV) of at least about 20,000 hr⁻¹, which corresponds to a weight hourly space velocity (WHSV) of about 200 hr¹, when the reactor is operated to produce synthesis gas. Preferably the reactor is operated at a reactant gas pressure greater than 2 atmospheres, which is advantageous for optimizing syngas production space-time yields.

In some embodiments, the reactant gas mixture is preheated to about 30° C.-750° C. before contacting the catalyst. The preheated feed gases pass through the catalytic materials to the point at which the partial oxidation reaction initiates. An overall or net catalytic partial oxidation (CPOX) reaction ensues, and the reaction conditions are maintained to promote continuation of the process, which preferably is sustained autothermally.

For the purposes of this disclosure, the term “net partial oxidation reaction” means that the partial oxidation reaction shown in Reaction 2, above, predominates. However, other reactions such as steam reforming (see Reaction 1), dry reforming (Reaction 3) and/or water-gas shift (Reaction 4) may also occur to a lesser extent.

CH₄+CO₂⇄2CO+2H₂ (3)

CO+H₂O⇄CO₂+H₂ (4)

The relative amounts of the CO and H₂ in the reaction product mixture resulting from the catalytic net partial oxidation of the methane, or natural gas, and oxygen feed mixture are about 2:1 H₂:CO, similar to the stoichiometric amounts produced in the partial oxidation reaction of Reaction 2.

As used herein, the term “autothermal” means that after initiation of the partial oxidation reaction, no additional or external heat must be supplied to the catalyst in order for the production of synthesis gas to continue. Under autothermal reaction conditions the feed is partially oxidized and the heat produced by that exothermic reaction drives the continued net partial oxidation reaction. Consequently, under autothermal process conditions there is no external heat source required. The net partial oxidation reaction conditions are promoted by optimizing the concentrations of hydrocarbon and O₂ in the reactant gas mixture, preferably within the range of about a 1.5:1 to about 3.3:1 ratio of carbon:O₂ by weight. In some embodiments, steam may also be added to produce extra hydrogen and to control the outlet temperature. The ratio of steam to carbon by weight ranges from 0 to 1. The carbon:O₂ ratio is the most important variable for maintaining the autothermal reaction and the desired product selectivities. Pressure, residence time, amount of feed preheat and amount of nitrogen dilution, if used, also affect the reaction products. The preferred process conditions include maintaining a catalyst residence time of no more than about 10 milliseconds for the reactant gas mixture. This is accomplished by passing the reactant gas mixture over, or through the porous structure of the catalyst system at a gas hourly space velocity of about 20,000-100,000,000 hr⁻¹, preferably about 100,000-25,000,000 hr⁻¹. This range of preferred gas hourly space velocities corresponds to a weight hourly space velocity of 1,000 to 25,000 hr⁻¹. In preferred embodiments of the process, the catalyst system catalyzes the net partial oxidation of at least 90% of a methane feedstock to CO and H₂ with a selectivity for CO and H₂ products of at least about 90% CO and 90% H₂.

In certain embodiments of the process, the step of maintaining net partial oxidation reaction promoting conditions includes keeping the temperature of the reactant gas mixture at about 30° C.-750° C.° C. and keeping the temperature of the catalyst at about 600-2,000° C., preferably between about 600-1,600° C., by self-sustaining reaction. In some embodiments, the process includes maintaining the reactant gas mixture at a pressure of about 100-32,000 kPa (about 1-320 atmospheres), preferably about 200-10,000 kPa (about 2-100 atmospheres), while contacting the catalyst.

In some embodiments, the process comprises mixing a methane-containing feedstock and an O₂-containing feedstock together in a carbon:O₂ ratio of about 1.5:1 to about 3.3:1, preferably about 1.7:1 to about 2.1:1, and more preferably about 2:1). Preferably the methane-containing feedstock is at least 80% methane, more preferably at least 90%. These and other embodiments, features and advantages of the present invention will become apparent with reference to the following description and drawings.

### BRIEF DESCRIPTION OF THE DRAWINGS

FIG. 1 is a graph showing the performance of a Co—Cr containing catalyst supported on zirconia granules (35-50 mesh) for production of synthesis gas, in accordance with certain embodiments of the invention.

FIG. 2 is a graph showing the performance of a Co—Cr containing catalyst supported on alumina granules (35-50 mesh) for production of synthesis gas, in accordance with certain embodiments of the invention.

### DETAILED DESCRIPTION OF PREFERRED EMBODIMENTS

A new family of syngas production catalysts contain cobalt-chromium oxide promoted with rhodium, cerium, or both, and further promoted by a lanthanide, lanthanide oxide or mixture of lanthanide and lanthanide oxide, such as Yb, Sm, La and their oxides, carried on refractory supports such as zirconia, alumina or cordierite, are described in the following representative examples. These new promoted Co—Cr oxide catalysts are capable of catalytically converting gaseous light hydrocarbons (e.g., such as methane or natural gas) to synthesis gas containing CO and H₂. They include a lanthanide-modified support having any of various three-dimensional geometries such as foams, extrudates, rings, monoliths, granules, spheres, pellets, beads, pills and particles. Although there has been a general increase in use of monolith or honeycomb type supports in order to overcome the relatively high pressure drop associated with gas flow through a fixed bed of catalyst particles, and to make possible the operation of the syngas reactor at high gas space velocities, in the present studies it has been found that a packed bed of granular supported catalysts generally perform better than their monolith counterparts in a short contact time CPOX reactor.

In particular, the preferred new Rh promoted Co—Cr oxide catalyst structures further promoted by a lanthanide, when prepared as described in the following examples, are very active syngas production catalysts with sufficient mechanical strength to withstand high pressures and temperatures and permit a high flow rate of reactant and product gases when employed on-stream in a short contact time reactor for synthesis gas production. Without wishing to be limited to a particular theory, it appears that the lanthanide promoter serves to lower the light-off and reaction temperatures and to reduce coking of the catalyst during operation. The new Rh and lanthanide promoted Co—Cr oxide catalysts are believed to be good substitutes for the more costly all rhodium catalysts that are commonly employed today for syngas production by CPOX.

The new catalysts are preferably prepared by impregnating or washcoating the promoter, cobalt and chromium components, or their precursors, onto a lanthanide coated refractory porous ceramic monolith carrier or support. “Lanthanide” refers to a rare earth element of the group La, Ce, Pr, Nd, Pm, Sm, Eu, Gd, Tb, Dy, Ho, Er, Tm, Yb and Lu. Some preferred supports include partially stabilized zirconia (PSZ) foam (stabilized with Mg, Ca or Y), or foams of α-alumina, corderite, titania, mullite, Zr-stabilized α-alumina, or mixtures thereof. A preferred laboratory-scale ceramic monolith support is porous PSZ foam with approximately 6,400 channels per square inch (80 pores per linear inch). Preferred foams for use in the preparation of the catalyst include those having from 30 to 150 pores per inch (12 to 60 pores per centimeter). The monolith can be cylindrical overall, with a diameter corresponding to the inside diameter of the reactor tube. Alternatively, other refractory foam and non-foam monoliths may serve as satisfactory supports. The catalyst precursors, including promoter and lanthanide salts, with or without a ceramic oxide support forming component, may be extruded to prepare a three-dimensional form or structure such as a honeycomb, foam, other suitable tortuous-path structure, and treated as described in the following Examples. The catalyst can be structured as, or supported on, a refractory oxide “honeycomb” straight channel extrudate or monolith, made of cordierite or mullite, or other configuration having longitudinal channels or passageways permitting high space velocities with a minimal pressure drop. Such configurations are known in the art and described, for example, in Structured Catalysts and Reactors, A. Cybulski and J. A. Moulijn (Eds.), Marcel Dekker, Inc., 1998, p. 599-615 (Ch. 21, X. Xu and J. A. Moulijn, “Transformation of a Structured Carrier into Structured Catalyst”).

A more preferred catalyst geometry is granules prepared by impregnating or washcoating the promoter, cobalt and chromium components, or their precursors, onto lanthanide coated refractory granules.

The following examples are offered by way of illustration, and not by way of limitation. Those skilled in the art will recognize that variations of the invention embodied in the examples can be made, especially in light of the teachings of the various references cited herein, the disclosures of which are incorporated by reference.

### EXAMPLE 1

### Co_{0.2}Cr_{0.8}Ox on PSZ Monolith

A cobalt-chromium oxide catalyst (Co_{0.2}Cr_{0 8}Ox, expressed in terms of atomic ratio of the metal components) on a refractory ceramic support was prepared according to the following procedure, given here for laboratory-scale batches:

30 g of Co(NO₃)₂.6H₂O and 82.919 g Cr₃(OH)₂(CH₃COO)₇ was dissolved in a minimal amount of deionized water to form an aqueous solution. The solution was rapidly frozen in liquid nitrogen, placed in a lyophilizer, and evacuated to dryness over a period of 5-7 days, or until completely dry. The freeze dried material was calcined in air according to the following schedule: 5° C./min ramp up to 350° C., hold for 5 h, 5° C./min up to 525° C., hold for 1 h, 10° C./min ramp down to room temperature. An aqueous slurry of the resulting Co_{0 2}Cr_{0.8}Ox was prepared and wash coated onto a partially stabilized (MgO) zirconia (PSZ) monolith. Suitable PSZ monoliths about 10 or 15 mm long and 12 mm diameter are commercially available from well known sources, such as Vesuvius Hi-Tech Ceramics, NY or Porvair Advanced Materials Inc., NC. The coated monolith was calcined at 700° C. for 4 h. The resulting catalyst is 10.6% Co_{0.2}Cr_{0.8}Ox on 80 ppi PSZ.

### EXAMPLE 2

### Co_{0.2}Cr_{0.8}Ox on a Yb-coated PSZ Monolith

A Yb-promoted Co_{0 2}Cr_{0 8}Ox catalyst on a refractory ceramic monolith is prepared as described in Example 1, except for the following modifications:

Yb(NO₃)₃.5H₂O is dissolved in sufficient water to form an aqueous solution. The PSZ monolith support is immersed into the Yb-solution for wet impregnation. The wet monolith is placed on a Teflon® plate residing on a warm (about 75° C.) hotplate and allowed to dry. The loaded monolith is then calcined in air according to the following schedule: 5° C./min ramp up to 350° C., hold for 2 h, 5° C./min up to 700° C., hold for 4 h, 10° C./min ramp down to room temperature.

30 g of Co(NO₃)₂.6H₂O and 82.919 g Cr₃(OH)₂(CH₃COO)₇ are dissolved in a minimal amount of deionized water to form an aqueous solution. The solution is rapidly frozen in liquid nitrogen, placed in a lyophilizer, and evacuated to dryness over a period of 5-7 days, or until completely dry. The freeze dried material is calcined in air according to the following schedule: 5° C./min ramp up to 350° C., hold for 5 h, 5° C./min up to 525° C., hold for 1 h, 10° C./min ramp down to room temperature. An aqueous slurry of the resulting Co_{0 2}Cr_{0 8}Ox is prepared and wash coated onto the Yb-coated PSZ monolith. The coated monolith is calcined at 700° C. for 4 h to provide a supported catalyst having the composition 10.6% Co_{0 2}CrOx/7%Yb₂O₃ on 80 ppi PSZ.

### EXAMPLE 3

### Rh-promoted Co_{0.2}Cr_{0.8}Ox on Yb-coated Ceramic Monolith

A rhodium-promoted cobalt-chromium catalyst, supported on a PSZ monolith, is prepared similarly to the catalyst of Example 2, except as modified in the following procedure:

Yb(NO₃)₃.5H₂O is dissolved in sufficient water to form an aqueous solution. The PSZ monolith support is immersed into the Yb-solution for wet impregnation. The solution is allowed to dry on a hot plate. The loaded monolith is then calcined in air according to the following schedule: 5° C./min ramp up to 350° C., hold for 2 h, 5° C./min up to 700° C., hold for 4 h, 10° C./min ramp down to room temperature.

30 g of Co(NO₃)₂.6H₂O and 82.919 g Cr₃(OH)₂(CH₃COO)₇ are dissolved amount of deionized water to form an aqueous solution. The solution is rapidly frozen in liquid nitrogen, placed in a lyophilizer, and evacuated to dryness over a period of 5-7 days, or until completely dry. The freeze dried material is calcined in air according to the following schedule: 5° C./min ramp up to 350° C., hold for 5 h, 5° C./min up to 525° C., hold for 1 h, 10° C./min ramp down to room temperature. An aqueous slurry of the resulting Co_{0 2}Cr_{0.8}Ox , together with a promoting amount of RhClₓ.XH₂O is prepared and wash coated onto the Yb-coated PSZ monolith. A promoting amount of the selected rhodium salt means that a sufficient amount is used to yield a promoting amount of rhodium in the final catalyst composition, preferably about 1% Rh. The coated monolith is calcined at 700° C. for 4 h. The catalyst is then reduced at 500° C. for 3 h under a combined stream of 300 mL/min H₂ and 300 mL/Min N₂. The composition of the final catalyst is 9.4% (Co_{0 2}Cr_{0 8}Ox)+1% Rh on 7.8% Yb₂O_{3 coated} 80 ppi PSZ.

### EXAMPLE 4

### Ce-promoted Co_{0.2}Cr_{0.8}Ox on PSZ Monolith

A Ce-promoted Co_{0.2}Cr_{0 8}Ox catalyst on an unmodified partially stabilized zirconia (PSZ) monolith support is prepared as described in Example 3, except cerium is substituted for rhodium and also acts as a promoter. The final composition of the supported catalyst is 10.1% (Co_{0 2}Cr_{0 8}Ox)+4% Ce on 80 ppi PSZ.

### EXAMPLE 5

### Rh-promoted Co_{0.2}Cr_{0.8}Ox on Yb-coated Zirconia Granules

A rhodium-promoted Co_{0 2}Cr_{0.8}Ox catalyst on Yb-coated refractory ceramic granules is prepared as described in Example 3, except ZrO₂ granules are substituted for the PSZ monolith support. The final wt % of the components are 6.7% (Co_{0.2}Cr_{0.8}Ox)+1%Rh on 6.0% Yb₂O₃ on 35-50 mesh ZrO₂ granules.

### EXAMPLE 6

### Rh-promoted Co_{0.2}Cr_{0.8}Ox on Yb-coated Al₂O₃ Granules

A rhodium-promoted Co_{0 2}Cr_{0.8}Ox catalyst on Yb-coated refractory ceramic granules is prepared as described in Example 5, except 35-50 mesh alpha-Al₂O₃ granules are substituted for the ZrO₂ granular support. The composition of the final supported catalyst is 6.56% (Co_{0.2}Cr_{0 8}Ox)+1%Rh on 6.52% Yb₂O₃ on 35-50 mesh Al₂O₃ granules.

Other suitable refractory support materials include zirconia stabilized alumina, yttrium stabilized zirconia, calcium stabilized zirconia, alumina and cordierite. The granule or spheres range in size from 50 microns to 6 mm in diameter (i.e., about 120 mesh, or even smaller, to about ¼ inch (about 6.35 mm diameter)). Preferably the particles are no more than 3 mm in their longest characteristic dimension, or range from about 80 mesh (0.18 mm) to about ⅛ inch (about 3.18 mm diameter), and more preferably about 35-50 mesh (about 0.3 to 0.5 mm diameter particles). The term “mesh” refers to a standard sieve opening in a screen through which the material will pass, as described in the Tyler Standard Screen Scale (C. J. Geankoplis, TRANSPORT PROCESSES AND UNIT OPERATIONS, Allyn and Bacon, Inc., Boston, Mass., p. 837), hereby incorporated herein by reference. Preferably the support materials are pre-shaped as granules, spheres, pellets, or other geometry that provides satisfactory engineering performance, before application of the catalytic materials. The BET surface area of blank 35-50 mesh ZrO₂ granules is about 35 m²/g, and that of a blank PSZ monolith (80 ppi or about 31.5 pores per centimeter) is about 0.609 m²/g.

Each of the catalysts of Examples 1-6 were evaluated in either a laboratory scale syngas production reactor or a high pressure syngas production reactor. The composition of the catalysts are summarized in Table 1 and the results of the tests on those samples are shown in Table 2.

Test Procedure

Representative catalysts prepared as described in the foregoing Examples were evaluated for their ability to catalyze the partial oxidation reaction in a conventional flow apparatus with a 19 mm O.D.×13 mm I.D. quartz insert embedded inside a refractory-lined steel vessel. The quartz insert contained the catalyst packed between two foam disks. The upper disk typically consisted of 65-ppi PSZ and the bottom disk typically consisted of 30-ppi zirconia-toughened alumina. Preheating the methane or natural gas that flowed through the catalyst system provided the heat needed to start the reaction. Oxygen was mixed with the methane or natural gas immediately before the mixture entered the catalyst system. The methane or natural gas was spiked with propane as needed to ignite the catalyst, then the propane was removed as soon as ignition occurred. Once the catalyst ignited, the reaction proceeded autothermally. Two Type K thermocouples with ceramic sheaths were used to measure catalyst inlet and outlet temperatures. The molar ratio of CH₄ to O₂ was generally about 2:1, however the relative amounts of the gases, the catalyst inlet temperature and the reactant gas pressure could be varied by the operator according to the particular parameters being evaluated. The product gas mixture was analyzed for CH₄, O₂, CO, H₂, CO₂ and N₂ using a gas chromatograph equipped with a thermal conductivity detector. A gas chromatograph equipped with flame ionization detector analyzed the gas mixture for CH₄, C₂H₆, C₂H₄ and C₂H₂. The CH₄ conversion levels and the CO and H₂ product selectivities obtained for each catalyst evaluated in this test system are considered predictive of the conversion and selectivities that will be obtained when the same catalyst is employed in a commercial scale short contact time reactor at least under similar conditions of reactant concentrations, temperature, reactant gas pressure and space velocity.

Catalyst testing at atmospheric pressure was conducted following a similar procedure to that outlined above, except that the quartz reactor was constructed without the refractory-lined steel vessel and an insulation blanket was placed around the catalyst section.

The catalyst composition of each Example is listed in Table 1. The performance of the representative compositions in catalyzing the production of synthesis gas is shown in Table 2.

TABLE 1
Composition of Catalysts

| | Co_{0.2}Cr_{0.8}Ox | Promoter | Yb₂O₃ | Type of |
|---|---|---|---|---|
| Ex. | (wt %) | (wt %) | (wt %) | Support |
| 1 | 10.6 | — | — | PSZ monolith |
| 2 | 10.6 | — | 7 | PSZ monolith |
| 3 | 9.4 | 1% Rh | 7.8 | PSZ monolith |
| 4 | 10.1 | 4% Ce | — | PSZ monolith |
| 5 | 6.7 | 1% Rh | 6.0 | ZrO₂ granules |
| 6 | 6.56 | 1% Rh | 6.52 | Al₂O₃ granules |

TABLE 2
Performance of Representative Catalysts for Syngas Production

| | Test conditions | | | | | | | |
|---|---|---|---|---|---|---|---|---|
| | Pressure | T | GHSV | Feed | Performance (%) | | | Light-off |
| Cat. | (psig) | (° C.) | (hr⁻¹) | ratio | X (CH₄) | S (H₂) | S (CO) | Temp (° C.) |
| Ex. 1 | 6.8 | 1178 | 196,900 | 1.76⁽¹⁾ | 61 | 68 | 87 | 300 |
| Ex. 2 | 4.9 | 827 | 184,000 | 2.0⁽¹⁾ | 74 | 85.8 | 93.0 | 233 |
| Ex. 3⁽⁴⁾ | 45 | 1150 | 2,562,000 | 1.05⁽²⁾ | 82 | 82 | 88 | —⁽³⁾ |
| Ex. 4 | 45 | 800- | 985,000 | 1.04⁽²⁾ | 85 | 97 | 91.7 | —⁽³⁾ |
| | | 1100 | | | | | | |
| Ex. 5 | 45 | 1030 | 990,000 | 1.06⁽²⁾ | 91 | 88 | 95 | —⁽³⁾ |
| Ex. 6 | 45 | 806 | 980,000 | 1.05⁽²⁾ | 92 | 92 | 95 | —⁽³⁾ |

Notes:
⁽¹⁾Methane to oxygen molar ratio
⁽²⁾Oxygen to natural gas mass ratio
⁽³⁾Light-off temperature was not recorded.
⁽⁴⁾This test was conducted on a 1.5″ I.D. reactor

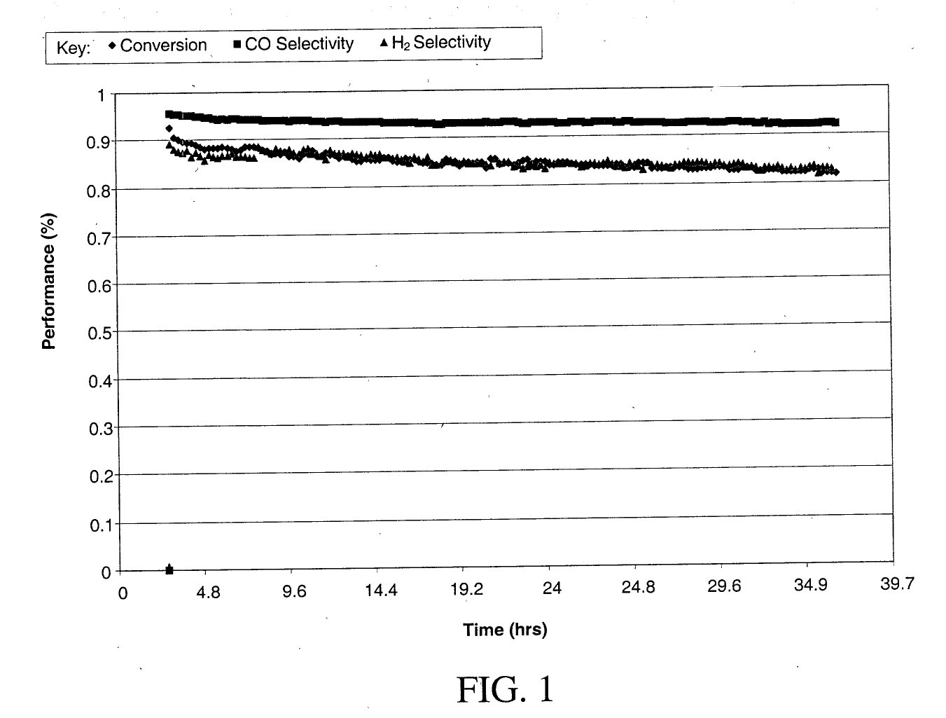

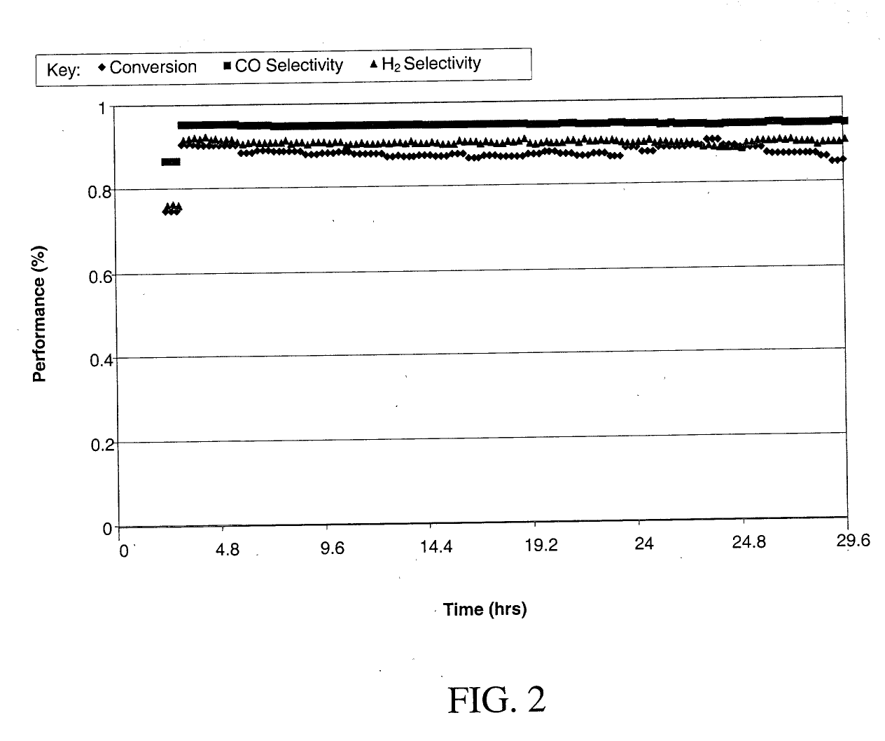

Other definitions in Table 2:

$${CH}_{4} conversion ( \% ) : X ( {CH}_{4} ) = \frac{Σ ( [ Ci ] \cdot n ) - [ {CH}_{4} ]}{Σ ( [ Ci ] \cdot n )} \times 100 \%$$

$$CO selectivity ( \% ) : S ( CO ) = \frac{[ CO ]}{Σ ( [ Ci ] \cdot n ) - [ {CH}_{4} ]} \times 100 \% ;$$

$$Hydrogen selectivity ( \% ) : S ( {H}_{2} ) = \frac{\frac{1}{2} \times {[ {H}_{2} ]}_{produced}}{{[ {CH}_{4} ]}_{in} - {[ {CH}_{4} ]}_{out}} \times 100 \%$$

wherein [CH₄]=methane molar flow in the product; [Ci]=molar flow of component i in the product; n=the number of carbon in component i. and [CO], molar flow of CO in the product. The modification of the supporting monolith or granules by a lanthanide oxide (preferably ytterbium oxide) before the Co—Cr oxide is applied significantly suppresses side reactions on the catalyst during catalytic syngas production. It can be seen in Table 2 that the catalyst employing the lanthanide oxide modified support had lowered ignition temperature and reaction temperature, reduced coking problems, and increased CH₄ conversion and selectivity rates for CO and H₂ products. By contrast, without Ln-modification of the support, the supported Co—Cr oxide catalysts produced severe side reactions which resulted in coking, high light off temperature, high reaction temperature and low conversion. It can also be seen in Table 2 that the presence of the Rh or Ce promoter significantly increased the CH₄ conversion, and stabilized the CO and H₂ selectivity. The substitution of a granular support such as ZrO₂ or alpha alumina for a similarly loaded monolith support significantly increased CH₄ conversion, and CO and H₂ selectivity. It also reduced the coking problem and increased the catalyst stability. The excellent performance (conversion and selectivity) of the catalysts of Example 5 (Rh-promoted Co_{0 2}Cr_{0 8}Ox on Yb-coated zirconia granules) and Example 6 (Rh-promoted Co_{0.2}Cr_{0.8}Ox on Yb-coated alumina granules) over approximately 30-40 hour continuous testing periods is shown in FIGS. 1 and 2, respectively.

Process of Producing Syngas

A process for producing synthesis gas employs a promoted Co—Cr oxide monolith or granular catalyst that is active in catalyzing the efficient conversion of methane or natural gas and molecular oxygen to primarily CO and H₂ by a net catalytic partial oxidation (CPOX) reaction.

Suitable cobalt-chromium oxide containing catalysts are prepared as described in the foregoing examples. Preferred catalysts comprise a rhodium, cerium or rhodium and cerium promoted cobalt-chromium oxide composition or compound of the general formula CoₓCr₁₋ₓ oxide (expressed in terms of atomic ratios of the metal components, wherein 0<x<1), preferably Co_{0.2}Cr_{0 8} oxide, deposited on a lanthanide coated granular support such as 30-50 mesh zirconia or alumina.

Preferably employing a very fast contact (i.e., millisecond range)/fast quench (i.e., less than one second) reactor assembly, a feed stream comprising a hydrocarbon feedstock and an oxygen-containing gas are mixed together and contacted with an above-described catalyst. One suitable reaction regime is a fixed bed reaction regime, in which the catalyst is retained within a reaction zone in a fixed arrangement. Short contact time syngas production reactors are described in co-owned U.S. Pat. No. 6,402,989, U.S. Pat. No. 6,409,940 and PCT International Publication No. WO 01/81241. The ratio of catalyst bed length to reactor diameter is preferably ≦⅛. The feed stream is contacted with the catalyst in a reaction zone maintained at autothermal net partial oxidation-promoting conditions effective to produce an effluent stream comprising primarily carbon monoxide and hydrogen. The hydrocarbon feedstock may be any gaseous hydrocarbon having a low boiling point, such as methane, natural gas, associated gas, or other sources of light hydrocarbons having from 1 to 5 carbon atoms. The hydrocarbon feedstock may be a gas arising from naturally occurring reserves of methane, which contain carbon dioxide. Preferably, the feed comprises at least about 50% by volume methane, more preferably at least 75% by volume, and most preferably at least 85% by volume methane.

The hydrocarbon feedstock is in the gaseous phase when contacting the catalyst. The hydrocarbon feedstock is contacted with the catalyst as a mixture with an O₂ containing gas (e.g., air, oxygen-enriched air, or pure oxygen), preferably pure oxygen. The hydrocarbon feedstock may be contacted with the catalyst as a mixture containing steam, CO₂, or both, along with a light hydrocarbon gas, as sometimes occurs in natural gas deposits.

The methane-containing feed and the O₂ containing gas are mixed in such amounts to give a carbon (i.e., carbon in methane) to oxygen (i.e., molecular oxygen) ratio from about 1.5:1 to about 3.3:1, more preferably, from about 1.7:1 to about 2.1:1. The stoichiometric molar ratio of about 2:1 (CH₄:O₂) is especially desirable in obtaining the net partial oxidation reaction products ratio of 2:1 H₂:CO. In some situations, such as when the methane-containing feed is a naturally occurring methane reserve, carbon dioxide may also be present in the methane-containing feed without detrimentally affecting the process. The process is operated at atmospheric or superatmospheric pressures, the latter being preferred. The pressures may be from about 100 kPa to about 32,000 kPa (about 1-320 atm), preferably from about 200 kPa to 10,000 kPa (about 2-100 atm).

The process is preferably operated at temperatures of from about 230° C. to about 2,000° C., preferably from about 600° C. to about 1,600° C. The hydrocarbon feedstock and the oxygen-containing gas are preferably pre-heated before contacting with the catalyst.

The hydrocarbon feedstock and the oxygen-containing gas may be passed over the catalyst at any of a variety of space velocities. Space velocities for the process, stated as gas hourly space velocity (GHSV), are from about 20,000 to about 100,000,000 hr⁻¹, preferably from about 100,000 to about 25,000,000 hr⁻¹. Although for ease in comparison with prior art systems space velocities at standard conditions have been used to describe the present invention, it is well recognized in the art that residence time is the inverse of space velocity and that the disclosure of high space velocities equates to low residence times on the catalyst. Under these preferred operating conditions a flow rate of reactant gases is maintained sufficient to ensure a residence time of no more than 200 milliseconds with respect to each portion of reactant gas in contact with the catalyst. Preferably the residence time is less than 50 milliseconds, and more preferably under 20 milliseconds. A contact time of 10 milliseconds or less is highly preferred. The product gas mixture emerging from the reactor is harvested and may be routed directly into any of a variety of applications. One such application for the CO and H₂ product stream is for producing higher molecular weight hydrocarbon compounds using Fischer-Tropsch technology.

While the preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. The disclosures of all patents, patent applications and publications cited herein are incorporated by reference. The discussion of certain references in the Description of Related Art, above, is not an admission that they are prior art to the present invention, especially any references that may have a publication date after the priority date of this application.

What is claimed is:

1. A supported catalyst comprising Co—Cr oxide and a promoter deposited on a refractory support coated with a lanthanide or lanthanide oxide, or both, said supported catalyst having activity for catalyzing the partial oxidation of methane to CO and H₂ when employed in the catalyst zone of a short contact time reactor under catalytic partial oxidation promoting conditions.

2. The catalyst of claim 1 wherein said promoter comprises rhodium, cerium or a mixture of rhodium and cerium.

3. The catalyst of claim 1 prepared by a method comprising:
obtaining cobalt-chromium oxide;
combining a decomposable promoter-containing compound with said cobalt-chromium oxide to yield a promoter, cobalt-chromium oxide intermediate;
depositing a decomposable lanthanide-containing compound onto a refractory support;
decomposing said lanthanide-containing compound to yield said lanthanide, lanthanide oxide, or mixture thereof, coated on said refractory support;
depositing said promoter and cobalt-chromium oxide intermediate on said coated refractory support;
decomposing said decomposable promoter-containing compound; and
stabilizing said catalyst.

4. The catalyst of claim 3 wherein said method of making further comprises reducing said promoter.

5. The catalyst of claim 3 wherein said step of obtaining said cobalt-chromium oxide intermediate includes mixing together a decomposable cobalt oxide precursor and a decomposable chromium oxide precursor, decomposing said precursors to yield said cobalt-chromium oxide, and said stabilizing includes heat treating said mixture to yield a cobalt-chromium oxide intermediate.

6. The catalyst of claim 5 wherein said method of making includes depositing a decomposable rhodium compound together with said cobalt-chromium oxide intermediate onto a lanthanide and/or lanthanide oxide coated refractory support.

7. The catalyst of claim 5 wherein said method of making includes depositing a decomposable cerium compound together with said cobalt-chromium oxide intermediate onto a lanthanide and/or lanthanide oxide coated refractory support.

8. The catalyst of claim 1 wherein said method of making comprises subjecting said catalyst, or an intermediate thereof, to at least one heat treatment, each said heat treatment including subjecting the catalyst, or intermediate thereof, to a defined heating and cooling program.

9. The catalyst of claim 8 wherein said method of making includes heating a catalyst intermediate at a first temperature sufficient to decompose said rhodium or cerium precursor or said lanthanide/lanthanide oxide precursor, and heating said catalyst or intermediate thereof at a second temperature higher than said first temperature.

10. The catalyst of claim 9 wherein said first temperature is in the range of about 125° C. -325° C., and said second temperature is in the range of about 300° C.-900° C.

11. The catalyst of claim 8 wherein said method of making includes a final heat treatment comprising subjecting the catalyst to a predetermined expected maximum reactor operating temperature.

12. The catalyst of claim 11 wherein said method of making comprises a final heat treatment that includes heating said catalyst to a temperature in the range of about 500-1,700° C.

13. The catalyst of claim 8 wherein said method of making comprises holding said catalyst at said temperatures for predetermined periods of time.

14. The catalyst of claim 13 wherein the holding time at said first or second temperature is about 30-1,440 min.

15. The catalyst of claim 14 wherein the holding time is about 60-240 min.

16. The catalyst of claim 8 wherein the heating and cooling program comprises heating the catalyst or intermediate at a rate of about 0.1-50° C./min.

17. The catalyst of claim 16 wherein the heating rate is about 1-5° C./min.

18. The catalyst of claim 1 wherein said lanthanide is at least one element chosen from the group consisting of La, Ce, Pr, Nd, Pm, Sm, Eu, Gd, Tb, Dy, Ho, Er, Tm, Yb and Lu

19. The catalyst of claim 1 comprising CoₓCr₁₋ₓ oxide, expressed in terms of atomic ratios of the metal components, wherein 0<x<1.

20. The catalyst of claim 19 comprising Co_{0 2}Cr_{0 8} oxide.

21. The catalyst of claim 1 wherein said support comprises a refractory material chosen from the group consisting of zirconia, MgO stabilized zirconia, zirconia stabilized alumina, yttrium stabilized zirconia, calcium stabilized zirconia, alumina, MgO stabilized alumina, cordierite, titania, silica, magnesia, niobia, ceria, vanadia, nitrides and carbides.

22. The catalyst of claim 21 wherein said support comprises a monolith.

23. The catalyst of claim 21 wherein said support comprises a plurality of discrete structures.

24. The catalyst of claim 23 wherein said discrete structures are chosen from the group consisting of particles, granules, pellets, pills, beads, trilobes, cylinders, extrudates and spheres.

25. The catalyst of claim 23 wherein each said discrete structure is about 0.125 mm to 3.81 cm in its longest characteristic dimension.

26. The catalyst of claim 23 wherein each said discrete structure is about 50 microns to 6 mm long in its longest characteristic dimension.

27. The catalyst of claim 26 wherein each said discrete structure is no more than 3 mm in its longest characteristic dimension.

28. A method of partially oxidizing a reactant gas mixture comprising a light hydrocarbon and oxygen to form a product mixture containing carbon monoxide and hydrogen, the method comprising passing said reactant gas mixture over the catalyst of claim 1 such that a product mixture containing CO and H₂ is produced.

29. The method of claim 28 comprising passing said reactant gas mixture over said catalyst at a gas hourly space velocity of at least 20,000 hr⁻¹.

30. The method of claim 28 comprising passing said reactant gas mixture over said catalyst at a gas hourly space velocity up to 100,000,000 hr⁻¹.

31. The method of claim 28 further comprising maintaining said reactant gas mixture at a pressure in excess of 100 kPa (about 1 atmosphere) while contacting said catalyst.

32. The method of claim 31 wherein said pressure is up to about 32,000 kPa (about 320 atmospheres).

33. The method of claim 31 wherein said pressure is between 200-10,000 kPa (about 2-100 atmospheres).

34. The method of claim 28 comprising maintaining a catalyst residence time of no more than 200 milliseconds for each portion of said reactant gas mixture passing said catalyst.

35. The method of claim 34 wherein said step of maintaining a catalyst residence time of no more than 200 milliseconds comprises passing said reactant gas mixture over said catalyst at a gas hourly space velocity in the range of about 20,000-100,000,000 hr⁻¹.

36. The method of claim 28 further comprising preheating said reactant gas mixture to about 30° C.-750° C. before contacting said catalyst.

37. The method of claim 28 comprising maintaining autothermal catalytic partial oxidation promoting conditions.

38. The method of claim 28 wherein said reactant gas mixture comprises a mixture of said methane or natural gas and said O₂-containing gas at a carbon:oxygen molar ratio of about 1.5:1 to about 3.3:1.

39. The method of claim 38 wherein said mixing comprises mixing said methane-containing feedstock and said O₂-containing feedstock at a carbon:oxygen molar ratio of about 2:1.

40. The method of claim 28 wherein said hydrocarbon comprises at least about 80% methane by volume.

41. A method of converting a light hydrocarbon and O₂ to a product mixture containing CO and H₂, the process comprising:
forming a reactant gas mixture comprising a light hydrocarbon containing gas and an O₂ containing gas; and
passing said reactant gas mixture over the catalyst of claim 3 at a reactant gas pressure of at least 200 kPa (about 2 atmospheres).

42. The method of claim 41 comprising maintaining a reactant gas mixture/catalyst contact time of no more than 200 milliseconds.

43. The method of claim 42 wherein said contact time is no more than 50 milliseconds.

44. The method of claim 43 wherein said contact time is no more than 20 milliseconds.

45. The method of claim 44 wherein said contact time is no more than 10 milliseconds.

46. The method of claim 41 comprising passing said reactant gas mixture over said catalyst at a gas hourly space velocity of at least 20,000 hr⁻¹.

47. The method of claim 41 comprising passing said reactant gas mixture over said catalyst at a gas hourly space velocity up to about 100,000,000 hr⁻¹.

48. The method of claim 41 comprising passing said reactant gas mixture over said catalyst at a gas hourly space velocity in the range of 100,000-25,000,000 hr⁻¹.

49. The method of claim 41 further comprising preheating said reactant gas mixture to about 30° C.-750° C. before contacting said catalyst.

50. The method of claim 41 further comprising adding a combustible gas to said reactant gas mixture sufficient to initiate a net catalytic partial oxidation reaction.

51. The method of claim 41 further comprising maintaining autothermal catalytic partial oxidation promoting conditions.

52. The method of claim 51 wherein said step of maintaining autothermal catalytic partial oxidation reaction promoting conditions comprises:
regulating the relative amounts of hydrocarbon and O₂ in said reactant gas mixture,
regulating the preheating of said reactant gas mixture,
regulating the operating pressure of said reactor,
regulating the space velocity of said reactant gas mixture, and
regulating the hydrocarbon composition of said hydrocarbon containing gas.

53. The method of claim 52 wherein said step of maintaining autothermal catalytic partial oxidation reaction promoting conditions includes keeping the preheat temperature of the reactant gas mixture in the range of 30° C.-750° C. and the temperature of the catalyst in the range of 600-2,000° C.

54. The method of claim 41 wherein comprising keeping the temperature of the catalyst in the range of 600-1,600° C.

55. The method of claim 41 wherein said mixing comprises mixing methane or natural gas and an O₂ containing gas to provide a reactant gas mixture having a carbon:oxygen molar ratio of about 1.5:1 to about 3.3:1.

56. The method of claim 55 wherein said mixing comprises mixing together said methane or natural gas and said O₂-containing gas in a carbon:oxygen molar ratio of about 1.7:1 to about 2.1:1.

57. The method of claim 56 wherein said mixing comprises mixing said methane-containing feedstock and said O₂-containing feedstock at a carbon:oxygen molar ratio of about 2:1.

58. The method of claim 41 wherein said light hydrocarbon comprises at least about 80% methane by volume.
